(19) United States
(12) Patent Application Publication
(10) Pub. No.: US 2019/0323531 A1
(43) Pub. Date: Oct. 24, 2019

(54) CAT TREE

(71) Applicant: DEMBY DEVELOPMENT CO., LTD., New Taipei City (TW)

(72) Inventor: Tsung-Hsiang Wang, New Taipei City (TW)

(21) Appl. No.: 16/387,575

(22) Filed: Apr. 18, 2019

(30) Foreign Application Priority Data
Apr. 24, 2018 (CN) 201820590394.4

(51) Int. Cl. F16B 7/04; A01K 15/02

(52) U.S. Cl. CPC F16B 7/042; A01K 15/02

(57) ABSTRACT

A cat tree is disposed between a first wall and a second wall, and has a supporting assembly, multiple platform assemblies, and at least one fixing assembly. The supporting assembly has two rods, and multiple bars. The two rods are parallelly disposed between the first wall and the second wall. Each one of the multiple bars is connected with the two rods, and has at least one installation hole. The multiple platform assemblies are mounted to the supporting assembly, and each one of the multiple platform assemblies has a platform body and at least one insert that protrudes from the platform body and is inserted into the at least one installation hole of one of the multiple bars. The at least one fixing assembly has a band connected to at least one of the first ends of the two rods and the multiple platform bodies.

### BACKGROUND OF THE INVENTION

### 1. Field of the Invention

The present invention relates to a pet utensil, and more particularly to a cat tree.

### 2. Description of Related Art

A conventional cat tree comprises a framework and multiple platforms that are connected to the framework at different heights. As an apparatus that pet cats can play and exercise on, the conventional cat tree provides a space for the pet cats to exhaust their energy and vigor jumping up and down over the multiple platforms. Consequently, the pet cats may grow healthy and be distracted from scratching furniture.

However, the conventional cat tree has the following shortcomings. The multiple platforms of the conventional cat tree are assembled on the framework via screws or bolts. Inevitably, a tool, e.g. a screw driver, is used to install or disassemble the conventional cat tree. That is to say, the assembly of the conventional cat tree is time-consuming, inconvenient, and difficult in use.

### SUMMARY OF THE INVENTION

The main objective of the present invention is to provide a cat tree which overcomes the shortcomings of the conventional cat tree.

The cat tree in accordance with the present invention is disposed between a first wall and a second wall non-parallel to the first wall, and has a supporting assembly, multiple platform assemblies, and at least one fixing assembly. The supporting assembly has two rods and multiple bars. The two rods are parallelly disposed, and each one of the two rods has a first end abutting the first wall and a second end abutting the second wall. Each one of the multiple bars is connected with the two rods, and has at least one installation hole. The multiple platform assemblies are mounted to the supporting assembly, and each one of the multiple platform assemblies has a platform body and at least one insert that protrudes from the platform body and is inserted into the at least one installation hole of one of the multiple bars. The at least one fixing assembly has a band connected to at least one of the first ends of the two rods and the multiple platform bodies.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a cat tree in accordance with the present invention;

FIG. 2 is a perspective view of the cat tree in FIG. 1, wherein stepping clothes of the cat tree are omitted;

FIG. 3 is an enlarged exploded perspective view of a part A of the cat tree in FIG. 1,

FIG. 4 is an enlarged exploded perspective view of a part B of the cat tree in FIG. 1,

FIG. 5 is an exploded view of a first configuration of a frame of the cat tree in FIG. 1,

FIG. 6 is an exploded view of a second configuration of the frame of the cat tree in FIG. 1;

FIG. 7 is an enlarged perspective view of the frame of the cat tree in FIG. 5, sheathed by a stepping cloth;

FIG. 8 is an enlarged perspective view of the frame of the cat tree in FIG. 6, sheathed by a stepping cloth;

FIG. 9 is an exploded perspective view of a first platform assembly of the cat tree in FIG. 1;

FIG. 10 is an exploded perspective view of a second platform assembly of the cat tree in FIG. 1;

FIG. 11 is an enlarged rear side perspective view of a part C of the cat tree in FIG. 1,

FIG. 12 is an enlarged rear side perspective view of a part D of the cat tree in FIG. 1; and

FIG. 13 is an enlarged rear side perspective view of a part E of the cat tree in FIG. 1.

### DETAILED DESCRIPTION OF THE PREFERRED EMBODIMENT

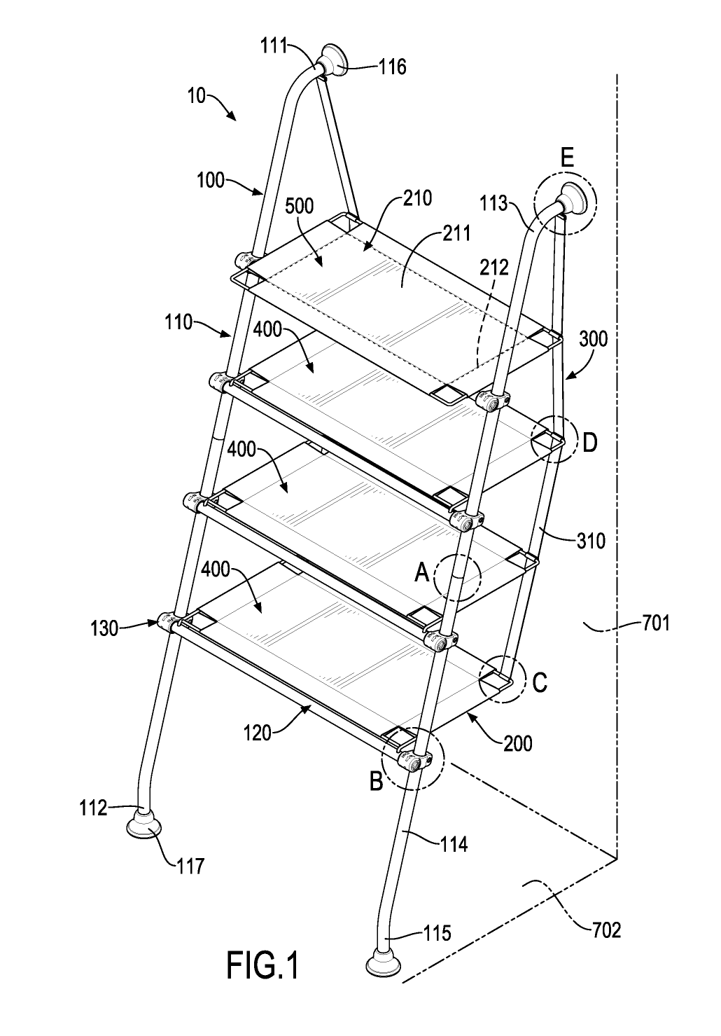

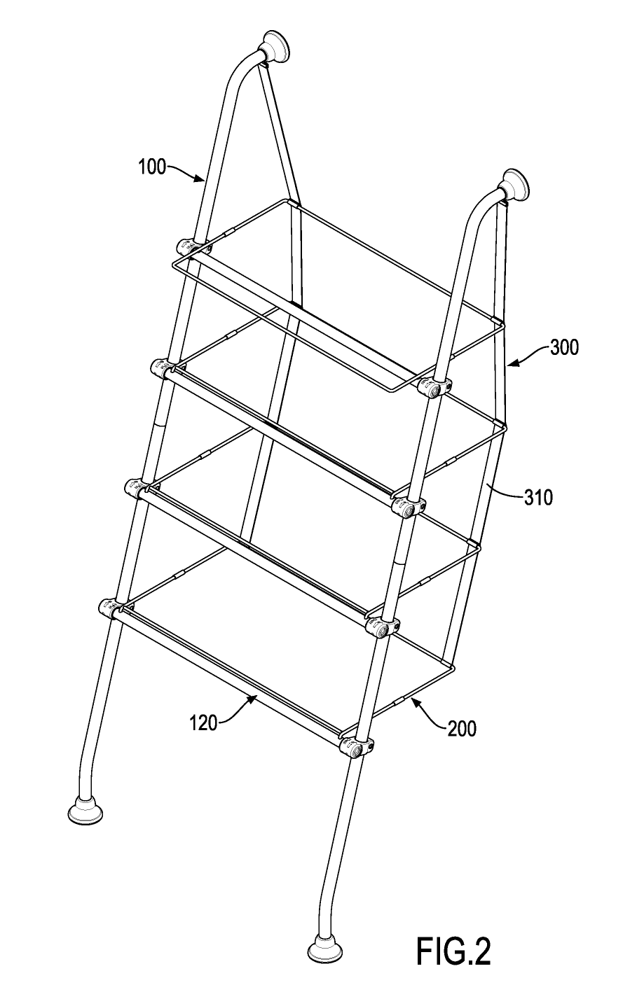

With reference to FIGS. 1 and 2, a cat tree 10 in accordance with the present invention is disposed between a first wall 701 and a second wall 702, so a pet cat may exercise thereon. In an embodiment of the present invention, the first wall 701 and the second wall 702 are perpendicular to each other. Preferably, the first wall 701 is an upright wall, and the second wall 702 is a ground.

The cat tree 10 comprises a supporting assembly 100, multiple platform assemblies 200, and at least one fixing assembly 300. In the present invention, two fixing assemblies 300 are preferred. The supporting assembly 100 has two rods 110 and multiple bars 120. The two rods 110 are parallel to each other and are obliquely disposed between the first wall 701 and the second wall 702. Each one of the multiple bars 120 is connected between the two rods 110. Each one of the multiple platform assemblies 200 is connected to a respective one of the multiple bars 120 with a side of the platform assembly 200. The bar 120 supports the corresponding platform assembly 200 uprightly. The two fixing assemblies 300 are connected to a side of each one of the multiple platform assemblies 200, wherein the side of each platform assembly 200 is away from the multiple bars 120. Each one of the two fixing assemblies 300 is connected to an upper end of a respective one of the two rods 110, so the two fixing assemblies 300 may provide the multiple platform assemblies 200 with upright pulling forces. The supporting assembly 100 and the two fixing assemblies 300 keep each one of the multiple platform assemblies 200 horizontal, and the pet cat may therefore step (either crouch or stand) on any one of the multiple platform assemblies 200.

With reference to FIGS. 1 to 4, each one of the two rods 110 has a first end 111 that abuts the first wall 701 and a second end 112 that abuts the second wall 702. Each one of the multiple bars 120 has at least one installation hole 121.

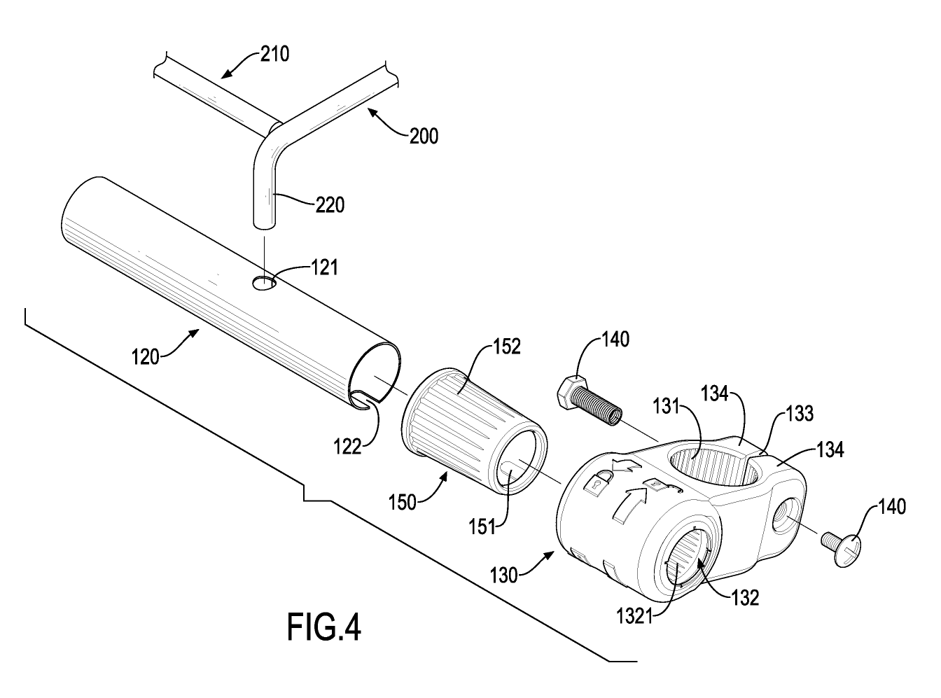

With reference to FIGS. 1 and 4, each one of the multiple platform assemblies 200 has a platform body 210 and at least one insert 220. The platform body 210 has a first face 211 and a second face 212, wherein the first face 211 is disposed nearer to the first ends 111 of the two rods 110 than the second face 212, and the pet cat steps on the first face 211. The at least one insert 220 is formed on and protrudes from the second face 212 of the platform body 210 of a same one of the multiple platform assemblies 200, and matches the at least one installation hole 121 to be inserted therein. An amount of the installation hole(s) 121 and an amount of the insert(s) 220 are the same, and one by one correspond.

In the present invention, each one of the multiple bars 120 has two installation holes 121 disposed on two ends of the bar 120, but the amount of the installation holes 121 may be changed into one or more.

Each one of the two fixing assemblies 300 has a band 310. The band 310 is connected to a side of each one of the multiple platform bodies 210 near the first wall 701. The band 310 has two ends. One of the two ends of the band 310 is connected to the first end 111 of a respective one of the two rods 110. The other one of the two ends of the band 310 is connected to the platform assembly 200 that is located bottommost. However, an amount of the fixing assembly 300 as well as the band 310 may be changed into one or more. If only one fixing assembly 300 is in use, a user may utilize a connecting bar to connect the first ends 111 of the two rods 110, so the band 310 of the fixing assembly 300 may be connected to the multiple platform bodies 210 with one end connected to the connecting bar.

Preferably, each one of the bands 310 is a woven band. Even so, the bands 310 may also have any one of banding, filiform, and planar structures in any practicable materials to pull the multiple platform assemblies 200.

To assemble one of the multiple platform assemblies 200, the user may, firstly, put the two inserts 220 (in the embodiment with the two installation holes 121) into the two installation holes 121. Then the user may use the two fixing assemblies 300 to connect the side of the platform body 210 near the first wall to the two rods 110. On the other hand, the user may also untie ends of the two fixing assemblies 300 that are connected to the two rods 110, and lift the platform assembly 200 to uninstall the platform assembly 200 easily. If the two fixing assemblies 300 are kept tied on the multiple platform assemblies 200, the multiple platform assemblies 200 would be installed to the supporting assembly 100 quickly next time. Assembly of the cat tree 10 is so convenient that no tool is necessary throughout the process mentioned above.

With further reference to FIGS. 1 and 2, since the two rods 110 are obliquely disposed between the first wall 701 and the second wall 702, the cat tree 10 is supported by the first wall 701 and the second wall 702 firmly and stably. The pet cat may thereby jump up and down safely on the cat tree 10.

Furthermore, each one of the two rods 110 has a horizontal portion 113, a main portion 114, and a vertical portion 115 that are serially connected. An end of the horizontal portion 113 away from the main portion 114 is the first end 111 of the rod 110, and an end of the vertical portion 115 away from the main portion 114 is the second end 112 of the rod 110. The horizontal portion 113 is perpendicular to the first wall 701, the vertical portion 115 is perpendicular to the second wall 702, and the main portion 114 is inclined toward the first wall 701. Preferably, an included angle between the main portion 114 and the first wall 701 is 16 degrees, and an included angle between the main portion 114 and the second wall 702 is thereby 74 degrees. Likewise, included angles may be of other values. For example, an included angle being right angle between the main portion 114 and the second wall 702 may be adopted for a cat tree 10 disposed uprightly.

In the present invention, with reference to FIG. 1, each one of the two rods 110 further comprises a first pad 116 and a second pad 117. The first pad 116 is mounted on the first end 111 of the rod 110, and the second pad 117 is mounted on the second end 112 of the rod 110. The first pad 116 and the second end 117 facilitate the cat tree 10 to be attached to the first wall 701 and the second wall 702 more firmly, so the cat tree 10 will not slip off the first wall 701 and the second wall 702.

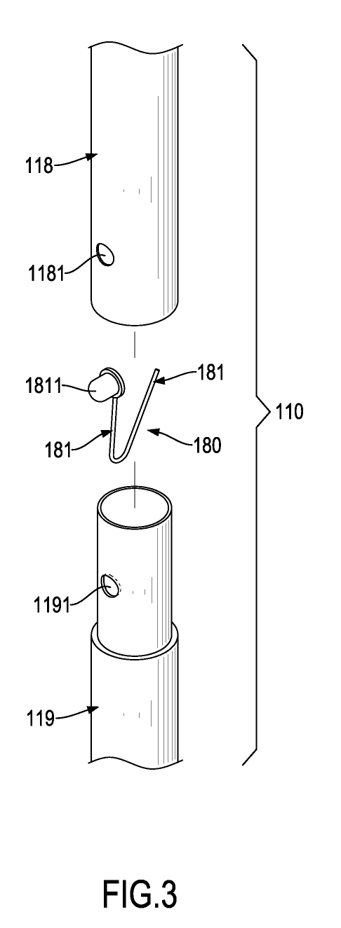

With reference to FIG. 3, each one of the two rods 110 is selectively made in multiple segments, wherein adjacent two of the multiple segments are able to be assembled, for convenience of storage and transportation of the two rods 110. In the present invention, the multiple segments are respectively a short tube, and comprise a first segment 118 and a second segment 119. The first segment 118 has a first mounting hole 1181 disposed therethrough. Similarly, the second segment 119 has a second mounting hole 1191 disposed therethrough. An end of the second segment 119 may be inserted into the first segment 118, and the first mounting hole 1181 and the second mounting hole 1191 are therewith aligned.

Each one of the two rods 110 may further have an elastomer 180. The elastomer 180 has two functional parts 181, and at least one of the two functional parts 181 has a protrusion 1811. The elastomer 180 is disposed in the second segment 119, and the two functional parts 181 abut against an inner wall of the second segment 119. The protrusion 1811 penetrates through the second mounting hole 1191 and the first mounting hole 1181 in order. Preferably, the elastomer 180 is V-shaped, wherein the two functional parts 181 are two ends of the letter V. Besides, the elastomer 180 may also be U-shaped or W-shaped in practice.

As the elastomer 180 is put into the second segment 119, the protrusion 1811 is pushed out through the second mounting hole 1191 due to an elastic restoring force. Afterward since the second mounting hole 1191 aligns with the first mounting hole 1181, and the second segment 119 is inserted into the first segment 118, the protrusion 1811 may be pushed further through the first mounting hole 1181 due to the same elastic restoring force. As a result, the two segments 118, 119 are connected via the elastomer 180. To conveniently dismount the two segments 118, 119, the user may easily pull the second segment 119 out of the first segment without any tool after pressing the protrusion 1811.

With reference to FIG. 4, in the present invention, the supporting assembly 100 further comprises multiple connectors 130 and multiple bolts 140, so each one of the multiple bars 120 may be moved back and forth along the two rods 110 thereby. Each one of the multiple connectors 130 has a first through hole 131, a second through hole 132, an opening 133, and two clip portions 134. The first through hole 131 and the second through hole 132 are disposed through the connector 130 and interlaced to each other. The connector 130 is sheathed on one of the two rods 110 via the first through hole 131. The connector 130 is connected to one of the multiple bars 120 at one of the two ends thereof. The opening 133 is disposed through the connector 130, and communicates with the first through hole 131. The two clip portions 134 are two portions of the connector 130 divided by the opening 133. In the present invention, two of the multiple bolts 140 are used to screw the two clip portions 134 together. By fastening the two bolts 140, the two clip portions 134 are screwed together, and the connector 130 would be fixed on the corresponding rod 110. By loosening the two bolts 140, the two clip portions 134 are spaced at an interval, so the connector 130 may be moved along the rod 110. Thus positions of the multiple bars 120 along the two rods 110 are conveniently adjustable.

In practice, the user may first of all sheathe the multiple connectors 130 on the two rods 110 via the first through holes 131, and then screw the clip portions 134 of the multiple connectors 130 with the multiple bolts 140 to fix the positions of the connectors 130. Eventually, mount each one of the multiple bars 120 between two of the multiple connectors 130 that are sheathed on different rods 110, so the multiple bars 120 are set at different heights. To remove the multiple connectors 130, the user may simply loosen all the bolts 140 and separate the connectors 130 from the corresponding rod 110.

Moreover, with reference to FIG. 4, the supporting assembly 100 preferably comprises multiple plugs 150 disposed in the second through holes 132 of the multiple connectors 130, respectively. By the multiple plugs 150, each one of the multiple bars 120 may be fixed more firmly to prevent rotation against the connectors 130. Each one of the two ends of the bar 120 is inserted into a respective one of the multiple plugs 150 in an interference fit. A restriction provided by the multiple plugs 150 may thereby decrease degrees of freedom of the multiple bars 120, and prevent the bars 120 from rotating.

In addition, each one of the multiple plugs 150 has a restriction block 151 and multiple ribs 152. The restriction block 151 is formed on and protrudes from an inner surface of the plug 150. The multiple ribs 152 protrude on an outer surface of the plug 150, and each rib 152 has an extending direction along a longitudinal direction of the corresponding bar 120. Conformably, each one of the multiple bars 120 has a U-shaped groove 122 disposed at each one of the two ends of the bar 120. The U-shaped groove 122 and the restriction block 151 match and abut each other. The second through hole 132 of each one of the multiple connectors 130 has multiple abutting grooves 1321 protruding on an inner surface of the second through hole 132. The multiple ribs 152 of each one of the multiple plugs 150 are wedged into the multiple abutting grooves 1321 of a respective one of the multiple connectors 130 as the plug 150 and the connector 130 are mounted.

When the multiple connectors 130 are sheathed on the two rods 110, the connectors 130 may be detachably mounted, or even be fixed (for example, to be welded). The user may sheathe the plugs 150 on the two ends of the bars 120, where the U-shaped grooves 122 and the restriction blocks 151 should be completely fit one by one.

Afterward the user may wedge the ribs 152 of one of the two plugs 150 into the abutting grooves 1321 of the corresponding connector 130, and then repeat the same act on the other end of the bar 120. Thereby the multiple bars 120 may be assembled to the two rods 110 with the multiple connectors 130. To disassemble the cat tree 10, the user may conveniently pull one of the two rods 110 against the other one of the two rods 110, and the pulled rod 110 and corresponding connectors 130 may be separated from the multiple bars 120.

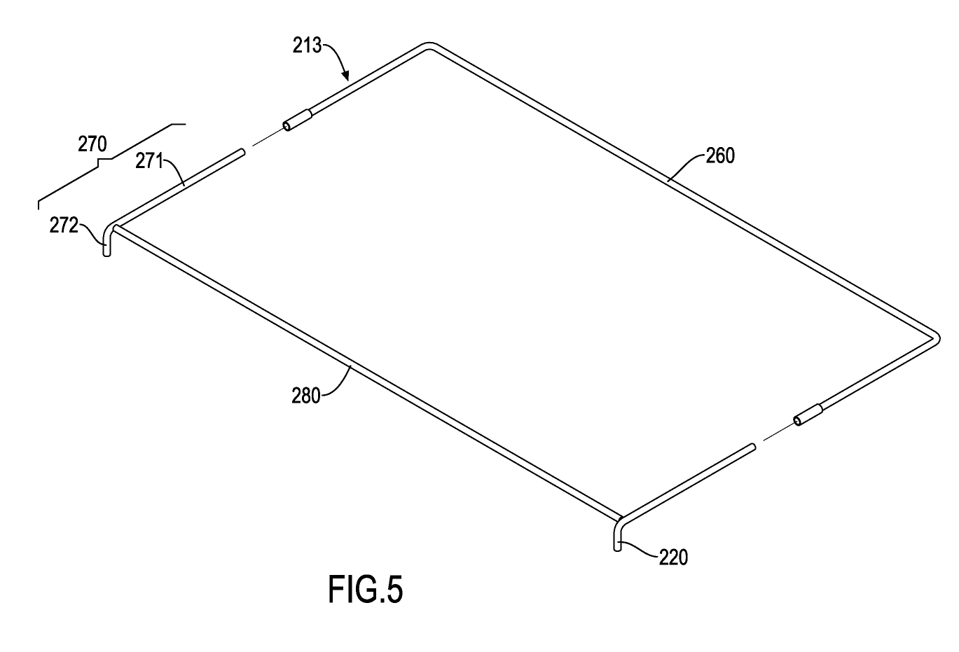

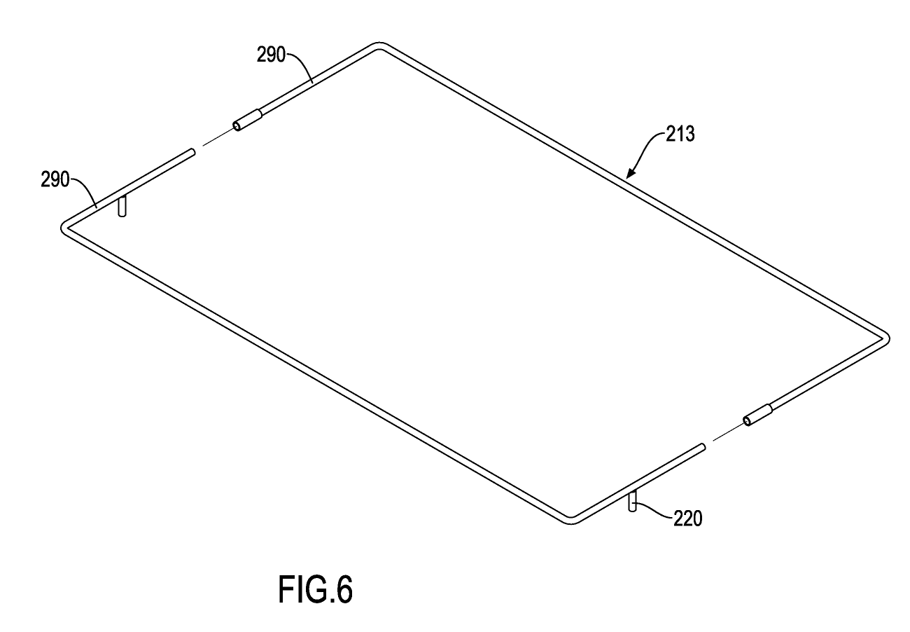

With reference to FIGS. 5 and 6, for convenience in dismounting and storage, each one of the multiple platform bodies 210 has a frame 213, and the at least one insert 220 protrudes on the frame 213.

With reference to FIG. 5, in a first configuration, the frame 213 comprises a first U-shaped tube 260, two L-shaped tubes 270, and a straight tube 280. The first U-shaped tube 260 has two ends. Each one of the two L-shaped tubes 270 has a first portion 271 and a second portion 272 perpendicularly connected to the first portion 271. The two first portions 271 of the two L-shaped tubes 270 are detachably mounted with the two ends of the first U-shaped tube 260, respectively. Two sockets may be utilized to connect the two L-shaped tubes 270 and the first U-shaped tubes 260. The two second portions 272 of the two L-shaped tubes 270 are formed to be the two said inserts 220. The straight tube 280 is detachably mounted with the two L-shaped tubes 270, wherein each one of two ends of the straight tube 280 is connected to a respective one of the two first portions 271. The straight tube 280 may also be welded to the two L-shaped tubes 270.

With reference to FIG. 6, in a second configuration, the frame 213 comprises two second U-shaped tubes 290. The two second U-shaped tubes 290 may be either detachably mounted or welded together. Two ends of one of the two second U-shaped tubes 290 are connected to two ends of the other second U-shaped tube 290. The two inserts 220 are disposed on two sides of one of the two second U-shaped tubes, respectively.

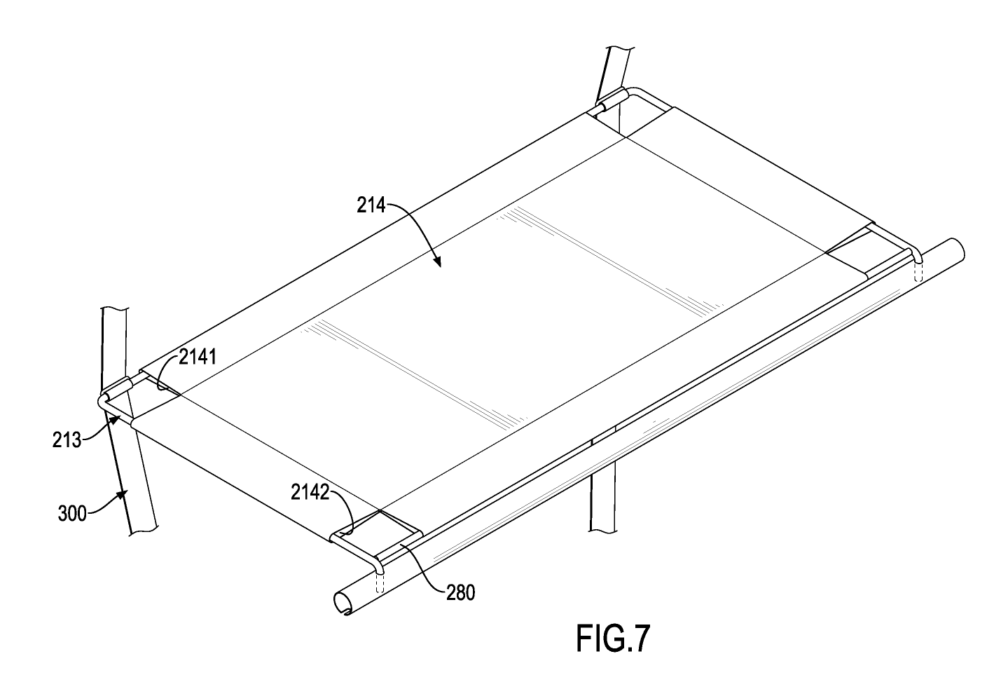

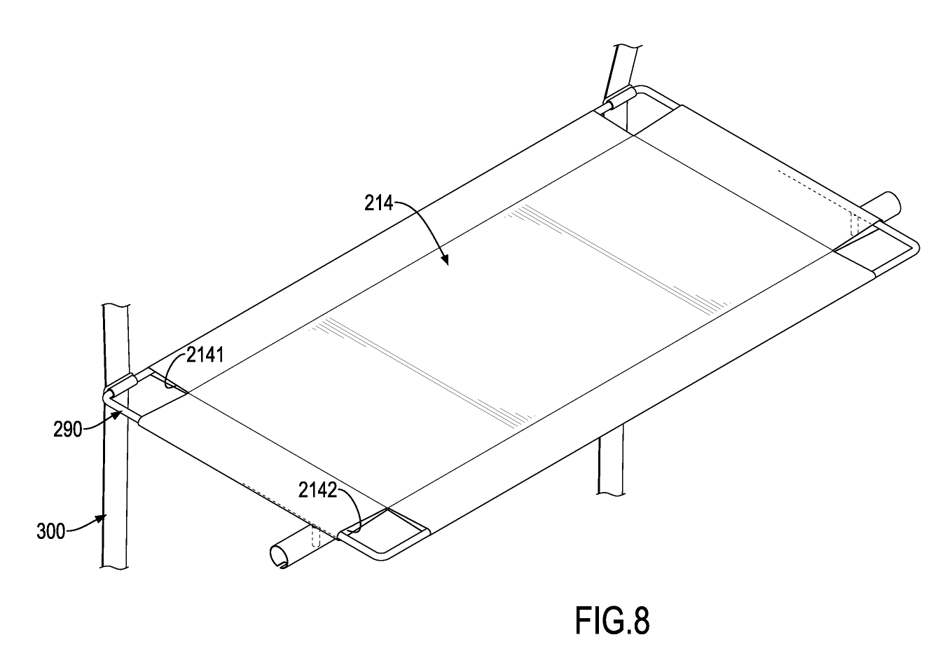

With reference to FIGS. 7 and 8, to create sufficient area for the pet cat, each one of the multiple platform bodies 210 has a stepping cloth 214 sheathed on the frame 213. Not covered by the stepping cloth 214, the two inserts 220 are either spaced from or protruded through the stepping cloth 214.

In the present invention, due to a rectangular structure of the frame 213, the stepping cloth 214 has two first sleeves 2141 and two second sleeves 2142. The two first sleeves 2141 correspond to two longer opposite sides of the frame 213, i.e. one of the two first sleeves 2141 sheathes a middle portion of the first U-shaped tube 260, and the other one of the first sleeves 2141 sheathes the straight tube 280. The two second sleeves 2142 correspond to two shorter opposite sides of the frame 213, and each one of the two second sleeves 2142 sheathes one of the two ends of the first U-shaped tube 260 and the corresponding first portion 271 of one of the two L-shaped tubes 270. As to the second configuration of the frame 213, each one of the two first sleeves 2141 sheathes a middle portion of a respective one of the two second U-shaped tubes 290, and the two second sleeves 2142 sheathe where the two second U-shaped tubes 290 are mutually connected.

Preferably, a central portion of the stepping cloth 214 is a grid structure, and four double-layer structures are connected around the grid structure. The four double-layer structures construct the two first sleeves 2141 and the two second sleeves 2142.

With reference to FIG. 1, since the two rods 110 are oblique, the higher one of the platform assemblies 200 is located thereon, the smaller a distance between the platform assembly 200 and the first wall 701 is. To avoid interferences between the multiple platform assemblies 200 and the first wall 701, a width of the higher-located platform assembly 200 should be smaller and smaller as the distance decreases. Accordingly, an area that the pet cat may step on becomes smaller along with increasing height.

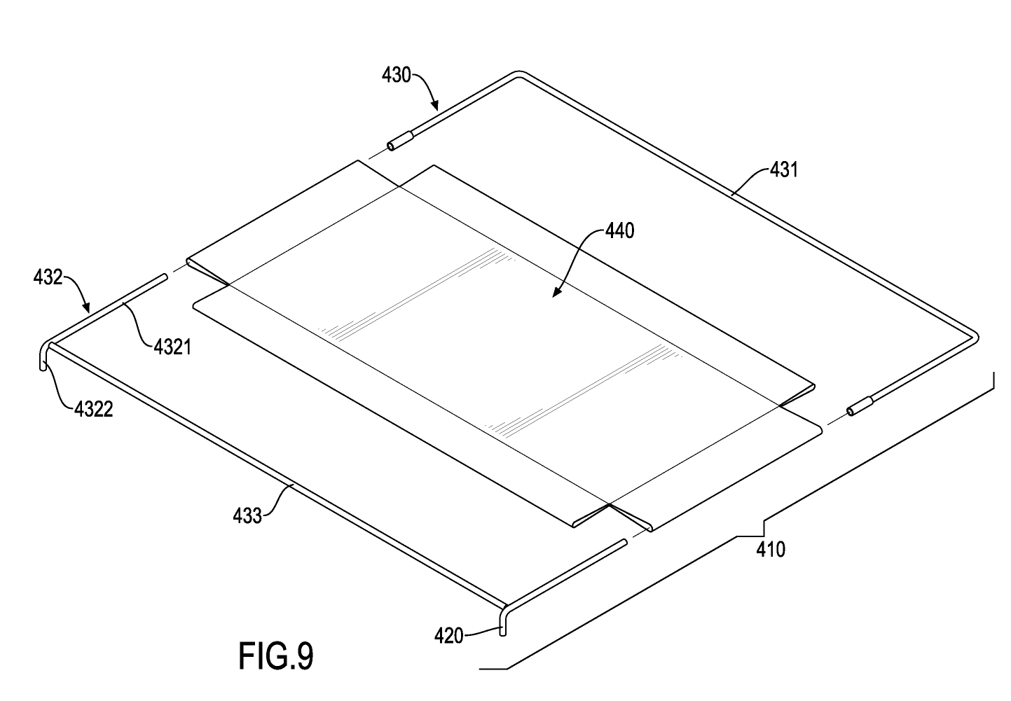

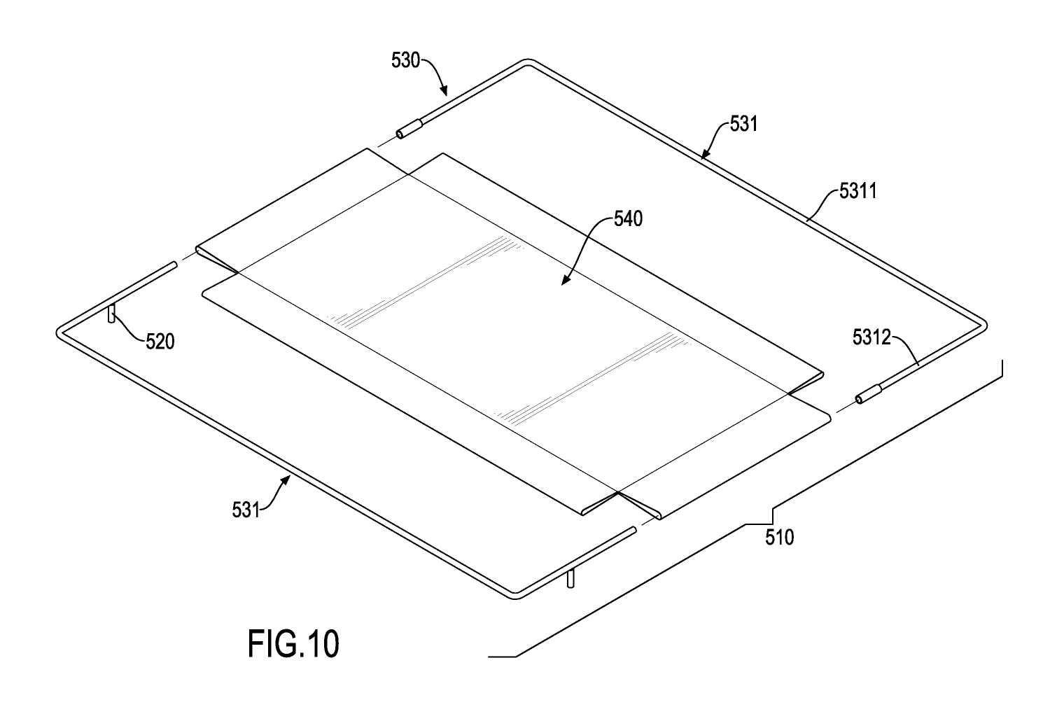

With reference to FIGS. 9 and 10, in the present invention, the multiple platform assemblies 200 comprise at least one first platform assembly 400 and a second platform assembly 500, so as to solve the aforementioned problem.

The at least one first platform assembly 400 has a first platform body 410 and two first inserts 420. The first platform body 410 has a first frame 430 and a first stepping cloth 440 sheathing the first frame 430. The first frame 430 comprises a first U-shaped tube 431, two L-shaped tubes 432, and a straight tube 433. The first U-shaped tube 431 has two ends. Each one of the two L-shaped tubes 432 has a first portion 4321 and a second portion 4322 perpendicularly connected to the first portion 4321. The two first portions 4321 of the two L-shaped tubes 432 are detachably mounted with the two ends of the first U-shaped tube 431, respectively. The two second portions 4322 of the two L-shaped tubes 432 are formed to be the two first inserts 420. The straight tube 433 is detachably mounted with the two L-shaped tubes 432, wherein each one of two ends of the straight tube 433 is connected to a respective one of the two first portions 4321.

The second platform assembly 500 has a second platform body 510 and two second inserts 520. The second platform body 510 has a second frame 530 and a second stepping cloth 540 sheathing the second frame 530. The second frame 530 comprises two second U-shaped tubes 531. Each one of the two second U-shaped tubes 531 comprises a middle division 5311 and two side divisions 5312. The two side divisions 5312 are connected to two ends of the middle division 5311, respectively. The two second U-shaped tubes 531 are detachably mounted via the two side divisions 5312 of each one of the two second U-shaped tubes 531. The two second inserts 520 protrude on the two side divisions 5312 of one of the two second U-shaped tubes 531, respectively.

In the present invention, the multiple platform assemblies 200 comprise three first platform assemblies 400 and a second platform assembly 500. The three first platform assemblies 400 and the second platform assembly 500 are parallelly connected to the supporting assembly 100 at spaced intervals, and the second platform assembly 500 is located topmost.

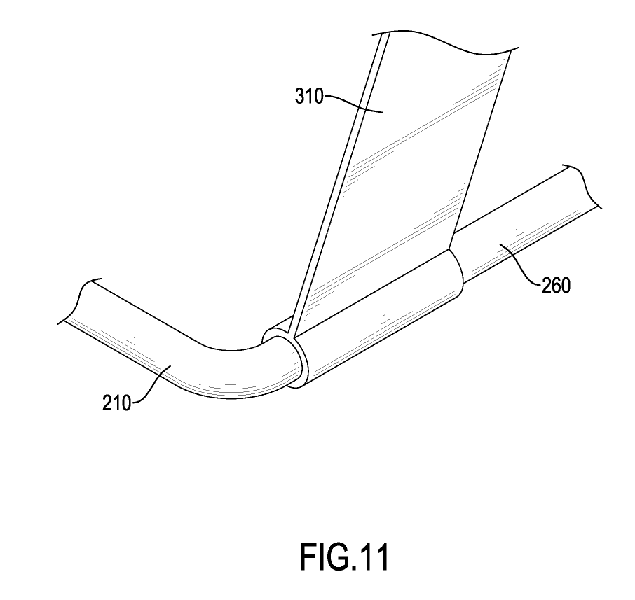

With reference to FIGS. 11 to 13, each one of the two fixing assemblies 300 further comprises multiple fixing components 320 and a fixing ring 330. One of the two ends of the band 310 may sheathe or be tied with the platform body 210 located bottommost (or nearest to the second ends 112 of the two rods 110), and the other end of the band 310 is fixed to the first end 111 of the corresponding rod 110 via the fixing ring 330. The band 310 is connected with each one of the multiple platform bodies 210 via a respective one of the multiple fixing components 320.

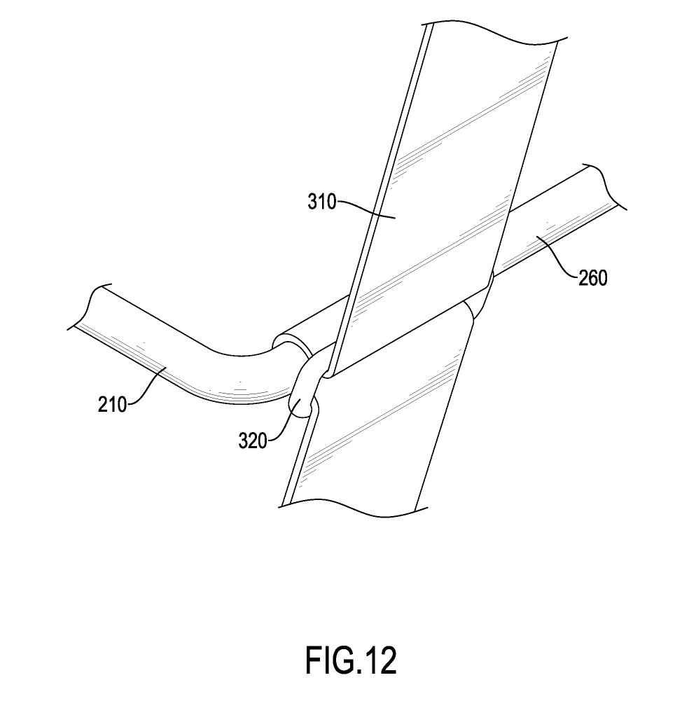

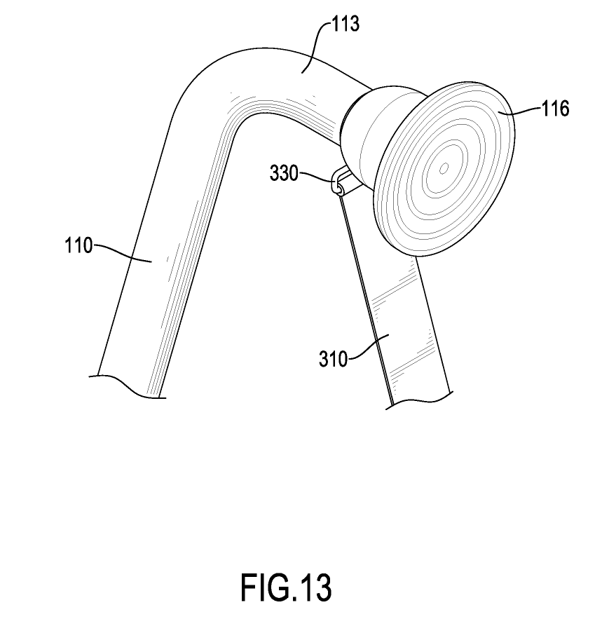

In detail, with further reference to FIG. 11, each one of the two fixing assemblies 300 utilizes the band 310 to twine a middle portion of the first U-shaped tube 431 of the bottommost-located first platform assembly 400. With reference to FIG. 12, the fixing assembly 300 utilizes the band 310 to sheathe the first U-shaped tubes 431 of the other first platform assemblies 400 and the second U-shaped tubes 531 of the second platform assembly 500 via the multiple fixing components 320. With reference to FIG. 13, the fixing assembly 300 is connected to the corresponding rod 110, wherein the fixing ring 330 is fixed to the first end 111 of the rod 110. Preferably, the fixing ring 330 may be hung on the horizontal portion 113 and abuts the first pad 116.

With the aforementioned technical characteristics, the present invention utilizes the inserts 220 on the platform bodies 210 and the installation holes 121 to achieve quick installation. Furthermore, the bands 310 connect the multiple platform assemblies 200 to the rods 110 to support and stabilize the platform assemblies 200. Therefore, the cat tree 10 may be conveniently installed and dismount without any tool.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A cat tree adapted to be disposed between a first wall and a second wall non-parallel to the first wall, and the cat tree comprising:
a supporting assembly having
two rods parallelly disposed, each one of the two rods comprising
a first end abutting the first wall; and
a second end abutting the second wall; and
multiple bars, each one of the multiple bars connected with the two rods and having at least one installation hole;
multiple platform assemblies mounted to the supporting assembly, and each one of the multiple platform assemblies comprising
a platform body; and
at least one insert protruding from the platform body and inserted into the at least one installation hole of one of the multiple bars; and
at least one fixing assembly comprising
a band connected to at least one of the first ends of the two rods and the multiple platform bodies.

2. The cat tree as claimed in claim 1, wherein each one of the two rods has
a horizontal portion perpendicular to the first wall;
a main portion oblique to the first wall; and
a vertical portion perpendicular to the second wall;
wherein the horizontal portion, the main portion, and the vertical portion are serially connected, the first end is an end of the horizontal portion away from the main portion, and the second end is an end of the vertical portion away from the main portion.

3. The cat tree as claimed in claim 1, wherein each one of the two rods comprises multiple segments, and two adjacent ones of the multiple segments are detachably connected.

4. The cat tree as claimed in claim 1, wherein the supporting assembly comprises
multiple connectors, each one of the multiple connectors sheathing one of the two rods via a first through hole of the connector, connected to a respective one of two ends of each one of the multiple bars via a second through hole of the connector, and having
an opening communicating with the first through hole; and
two clip portions divided by the opening and detachably mounted by bolts.

5. The cat tree as claimed in claim 4, wherein the supporting assembly further comprises
multiple plugs, each one of the multiple plugs disposed in the second through hole of one of the multiple connectors, and mounted with one of two ends of one of the multiple bars in an interference fit.

6. The cat tree as claimed in claim 5, wherein
each one of the multiple bars has a U-shaped groove disposed at each one of the two ends of the bar; and
each one of the multiple plugs has a restriction block matching and abutting the U-shaped groove of a respective one of the two ends of the bar.

7. The cat tree as claimed in claim 5, wherein
each one of the multiple plugs has multiple ribs protruding thereon and having an extending direction along a longitudinal direction of a respective one of the multiple bars; and
the second through hole of each one of the multiple connectors has multiple abutting grooves wedged with the multiple ribs of a respective one of the multiple plugs.

8. The cat tree as claimed in claim 5, wherein
each one of the multiple bars has a U-shaped groove disposed at each one of the two ends of the bar;
each one of the multiple plugs has
multiple ribs protruding thereon and having an extending direction along a longitudinal direction of a respective one of the multiple bars; and
a restriction block matching and abutting the U-shaped groove of a respective one of the two ends of the corresponding bar; and
the second through hole of each one of the multiple connectors has multiple abutting grooves wedged with the multiple ribs of a respective one of the multiple plugs.

9. The cat tree as claimed in claim 1, wherein the platform body has a frame and a stepping cloth sheathing the frame, and the at least one insert disposed on the frame and uncovered by the stepping cloth.

10. The cat tree as claimed in claim 9, wherein the frame has
a first U-shaped tube having two ends;
two L-shaped tubes, each of the two L-shaped tubes having
a first portion detachably mounted with a respective one of the two ends of the first U-shaped tube; and
a second portion perpendicularly connected to the first portion, and forming the insert; and
a straight tube detachably mounted with the two L-shaped tubes.

11. The cat tree as claimed in claim 9, wherein the frame has
two second U-shaped tubes detachably mounted together, and the insert disposed on one of the two second U-shaped tubes.

12. The cat tree as claimed in claim 9, wherein
each one of the frames of some of the multiple platform assemblies has
a first U-shaped tube having two ends;
two L-shaped tubes, each of the two L-shaped tubes having
a first portion detachably mounted with a respective one of the two ends of the first U-shaped tube; and
a second portion perpendicularly connected to the first portion, and forming the insert; and
a straight tube detachably mounted with the two L-shaped tubes; and
the frame of at least one of the multiple platform assemblies has
two second U-shaped tubes detachably mounted together, and the insert disposed on one of the two second U-shaped tubes.

13. The cat tree as claimed in claim 1, wherein the multiple platform assemblies comprise
at least one first platform assembly mounted to one of the multiple bars and having
a platform body having
a first frame having
a first U-shaped tube;
two L-shaped tubes, each of the two L-shaped tubes having a first portion detachably mounted with a respective one of two ends of the first U-shaped tube; and
a second portion perpendicularly connected to the first portion, and forming two first inserts; and
a straight tube detachably mounted with the two L-shaped tubes; and
a first stepping cloth sheathing the first frame; and
a second platform assembly mounted to one of the multiple bars, located nearer to the first ends of the two rods than the at least one first platform assembly, and having
a second platform body having
a second frame having
two second U-shaped tubes detachably mounted together, and having
a middle division; and
two side divisions, each one of the two side divisions connected to a respective one of two ends of the middle division, and detachably mounted with one of the two side divisions of the other one of the two second U-shaped tubes; and
a second stepping cloth sheathing the second frame; and
two second inserts protruding on the two side divisions, respectively.

14. The cat tree as claimed in claim 1, wherein
the multiple bars of the supporting assembly are disposed parallelly;
the platform assemblies are one by one mounted with the multiple bars;
the at least one fixing assembly further comprises multiple fixing components and a fixing ring; and
the band is connected to the multiple platform bodies via the multiple fixing components except one of the platform bodies nearest to the second wall, and is connected to the at least one of the two rods via the multiple fixing rings of the multiple fixing components.
